(19) United States
(12) Patent Application Publication
(10) Pub. No.: US 2016/0217731 A1
(43) Pub. Date: Jul. 28, 2016

(54) ORGANIC LIGHT-EMITTING DIODE (OLED) DISPLAY AND METHOD OF ADJUSTING LUMINANCE OF A LOGO REGION OF AN IMAGE DISPLAYED ON THE SAME

(71) Applicant: Samsung Display Co., Ltd., Yongin-si (KR)

(72) Inventors: Mi-Young Joo, Hwaseong-si (KR); Seung-Ho Park, Suwon-si (KR); Kang-Hee Lee, Suwon-si (KR); Myung-Hee Han, Seoul (KR)

(21) Appl. No.: 14/839,620

(22) Filed: Aug. 28, 2015

(30) Foreign Application Priority Data
Jan. 27, 2015 (KR) 10-2015-0012521

(51) Int. Cl. G09G 3/32; G09G 3/20

(52) U.S. Cl. CPC G09G 3/3208; G09G 3/2003; G09G 2320/0233; G09G 2320/0271; G09G 2360/16; G09G 2300/0842; G09G 2310/08

(57) ABSTRACT

An organic light-emitting diode (OLED) display and method of adjusting luminance of a logo region of an image displayed on the same are disclosed. In one aspect, the OLED display includes a display panel configured to display an image including a logo region. The display panel includes a plurality of red, green, and blue color pixels. The OLED display also includes a display driver configured to drive the display panel and reduce the luminance of blue color light emitted from blue color pixels located in the logo region.

### CROSS-REFERENCE TO RELATED APPLICATION(S)

This application claims priority under 35 USC §119 to Korean Patent Application No. 10-2015-0012521, filed on Jan. 27, 2015 in the Korean Intellectual Property Office (KIPO), the contents of which are incorporated herein in its entirety by reference.

### BACKGROUND

1. Field

The described technology generally relates to an organic light-emitting diode (OLED) display and a method of adjusting luminance of a logo region of a displayed image.

2. Description of the Related Technology

Recently, the use of OLED displays in electronic devices such as mobile phones and televisions has been widespread. In an OLED display, each pixel emits light by supplying a current to OLEDs in each of the pixels. Here, the OLED may degrade (e.g., deteriorate) due to the current supplied to the OLEDs. Thus, OLED displays can compensate image data such that a higher current is applied to the OLEDs. That is, when the image data is modified to compensate for a degraded pixel, it will emit light with substantially the same luminance as a non-degraded pixel. However, image data compensation is limited, and thus, a viewer may observe or perceive luminance degradation resulting from pixel degradation (i.e., degradation of the OLEDs).

### SUMMARY OF CERTAIN INVENTIVE ASPECTS

One inventive aspect is an organic light-emitting diode (OLED) display that can reduce pixel degradation caused due to a logo region of an image displayed on a display panel and a method of adjusting luminance of a logo region of an image for the OLED display.

Another aspect is an OLED display that can reflect pixel characteristics related to a lifetime of a display panel (e.g., a lifetime characteristic of a red color pixel that outputs red color light, a lifetime characteristic of a green color pixel that outputs green color light, and a lifetime characteristic of a blue color pixel that outputs blue color light) when the OLED display reduces luminance of a logo region of an image displayed on the display panel to alleviate a permanent afterimage due to a luminance difference or a color difference between the logo region of the image and a non-logo region of the image.

Another aspect is a method of adjusting luminance of a logo region of an image for an OLED display that can reduce the luminance of the logo region of the image by reflecting pixel characteristics related to a lifetime of a display panel included in the OLED display (e.g., a lifetime characteristic of a red color pixel that outputs red color light, a lifetime characteristic of a green color pixel that outputs green color light, and a lifetime characteristic of a blue color pixel that outputs blue color light).

Another aspect is an OLED display including a display panel configured to display an image including a logo region, the display panel including a red color pixel that outputs red color light, a green color pixel that outputs green color light, and a blue color pixel that outputs blue color light, and a display driving integrated circuit configured to drive the display panel and to reduce luminance of the logo region by reducing luminance of the blue color light output from the blue color pixel located in the logo region.

In example embodiments, the display driving integrated circuit can determine a logo surrounding region of the image that surrounds the logo region by detecting the logo region, can calculate average luminance of the blue color light of the logo surrounding region, can determine target luminance of the blue color light based on the average luminance of the blue color light of the logo surrounding region, and can reduce the luminance of the blue color light of the logo region to be substantially the same as the target luminance of the blue color light.

In example embodiments, the display driving integrated circuit can adjust an amount of luminance reduction of the blue color light based on degradation information of the blue color pixel located in the logo region.

In example embodiments, the display driving integrated circuit can increase the amount of the luminance reduction of the blue color light as a degradation degree of the blue color pixel located in the logo region increases.

In example embodiments, the display driving integrated circuit can further reduce the luminance of the logo region by reducing luminance of the green color light output from the green color pixel located in the logo region. In addition, an amount of luminance reduction of the blue color light output from the blue color pixel located in the logo region can be larger than an amount of luminance reduction of the green color light output from the green color pixel located in the logo region.

In example embodiments, the display driving integrated circuit can determine a logo surrounding region of the image that surrounds the logo region by detecting the logo region, can calculate average luminance of the blue color light of the logo surrounding region and average luminance of the green color light of the logo surrounding region, can determine target luminance of the blue color light and target luminance of the green color light based on the average luminance of the blue color light of the logo surrounding region and the average luminance of the green color light of the logo surrounding region, and can reduce the luminance of the blue color light of the logo region to be substantially the same as the target luminance of the blue color light and the luminance of the green color light of the logo region to be substantially the same as the target luminance of the green color light.

In example embodiments, the display driving integrated circuit can adjust the amount of the luminance reduction of the blue color light based on degradation information of the blue color pixel located in the logo region. In addition, the display driving integrated circuit can adjust the amount of the luminance reduction of the green color light based on degradation information of the green color pixel located in the logo region.

In example embodiments, the display driving integrated circuit can increase the amount of the luminance reduction of the blue color light as a degradation degree of the blue color pixel located in the logo region increases. In addition, the display driving integrated circuit can increase the amount of the luminance reduction of the green color light as a degradation degree of the green color pixel located in the logo region increases.

In example embodiments, the display driving integrated circuit can further reduce the luminance of the logo region by reducing luminance of the red color light output from the red color pixel located in the logo region. In addition, an amount of luminance reduction of the blue color light output from the blue color pixel located in the logo region can be larger than an amount of luminance reduction of the red color light output from the red color pixel located in the logo region.

In example embodiments, the display driving integrated circuit can determine a logo surrounding region of the image that surrounds the logo region by detecting the logo region, can calculate average luminance of the blue color light of the logo surrounding region and average luminance of the red color light of the logo surrounding region, can determine target luminance of the blue color light and target luminance of the red color light based on the average luminance of the blue color light of the logo surrounding region and the average luminance of the red color light of the logo surrounding region, and can reduce the luminance of the blue color light of the logo region to be substantially the same as the target luminance of the blue color light and the luminance of the red color light of the logo region to be substantially the same as the target luminance of the red color light.

In example embodiments, the display driving integrated circuit can adjust the amount of the luminance reduction of the blue color light based on degradation information of the blue color pixel located in the logo region. In addition, the display driving integrated circuit can adjust the amount of the luminance reduction of the red color light based on degradation information of the red color pixel located in the logo region.

In example embodiments, the display driving integrated circuit can increase the amount of the luminance reduction of the blue color light as a degradation degree of the blue color pixel located in the logo region increases. In addition, the display driving integrated circuit can increase the amount of the luminance reduction of the red color light as a degradation degree of the red color pixel located in the logo region increases.

In example embodiments, the display driving integrated circuit can further reduce the luminance of the logo region by reducing luminance of the green color light output from the green color pixel located in the logo region and luminance of the red color light output from the red color pixel located in the logo region. In addition, an amount of luminance reduction of the blue color light output from the blue color pixel located in the logo region can be larger than an amount of luminance reduction of the green color light output from the green color pixel located in the logo region and an amount of luminance reduction of the red color light output from the red color pixel located in the logo region. Furthermore, the amount of the luminance reduction of the green color light output from the green color pixel located in the logo region can be larger than the amount of the luminance reduction of the red color light output from the red color pixel located in the logo region.

In example embodiments, the display driving integrated circuit can determine a logo surrounding region of the image that surrounds the logo region by detecting the logo region, can calculate average luminance of the blue color light of the logo surrounding region, average luminance of the green color light of the logo surrounding region, and average luminance of the red color light of the logo surrounding region, can determine target luminance of the blue color light, target luminance of the green color light, and target luminance of the red color light based on the average luminance of the blue color light of the logo surrounding region, the average luminance of the green color light of the logo surrounding region, and the average luminance of the red color light of the logo surrounding region, and can reduce the luminance of the blue color light of the logo region to be substantially the same as the target luminance of the blue color light, the luminance of the green color light of the logo region to be substantially the same as the target luminance of the green color light, and the luminance of the red color light of the logo region to be substantially the same as the target luminance of the red color light.

In example embodiments, the display driving integrated circuit can adjust the amount of the luminance reduction of the blue color light based on degradation information of the blue color pixel located in the logo region. In addition, the display driving integrated circuit can adjust the amount of the luminance reduction of the green color light based on degradation information of the green color pixel located in the logo region. Furthermore, the display driving integrated circuit can adjust the amount of the luminance reduction of the red color light based on degradation information of the red color pixel located in the logo region.

In example embodiments, the display driving integrated circuit can increase the amount of the luminance reduction of the blue color light as a degradation degree of the blue color pixel located in the logo region increases. In addition, the display driving integrated circuit can increase the amount of the luminance reduction of the green color light as a degradation degree of the green color pixel located in the logo region increases. Furthermore, the display driving integrated circuit can increase the amount of the luminance reduction of the red color light as a degradation degree of the red color pixel located in the logo region increases.

In example embodiments, the display driving integrated circuit can include a scan driver configured to provide a scan signal to the display panel, a data driver configured to provide a data signal to the display panel, a logo controller configured to generate compensated image data by reducing the luminance of the logo region on image data input from outside, and a timing controller configured to control the scan driver, the data driver, and the logo controller.

In example embodiments, the display driving integrated circuit can further include a memory device configured to store degradation information of the blue color pixel, degradation information of the green color pixel, and degradation information of the red color pixel by accumulating the image data applied to the blue color pixel, the green color pixel, and the red color pixel.

Another aspect is a method of adjusting luminance of a logo region of an image for an OLED display including an operation of detecting a logo region of an image that is displayed on a display panel, an operation of determining a logo surrounding region of the image that surrounds the logo region, an operation of calculating average luminance of blue color light of the logo surrounding region, average luminance of green color light of the logo surrounding region, and average luminance of red color light of the logo surrounding region, an operation of determining target luminance of the blue color light, target luminance of the green color light, and target luminance of the red color light based on the average luminance of the blue color light of the logo surrounding region, the average luminance of the green color light of the logo surrounding region, and the average luminance of the red color light of the logo surrounding region, and an operation of reducing the luminance of the blue color light of the logo region to be substantially the same as the target luminance of the blue color light, the luminance of the green color light of the logo region to be substantially the same as the target luminance of the green color light, and the luminance of the red color light of the logo region to be substantially the same as the target luminance of the red color light. Here, an amount of luminance reduction of the blue color light output from the blue color pixel located in the logo region can be determined to be larger than an amount of luminance reduction of the green color light output from the green color pixel located in the logo region and an amount of luminance reduction of the red color light output from the red color pixel located in the logo region. In addition, the amount of the luminance reduction of the green color light output from the green color pixel located in the logo region can be determined to be larger than the amount of the luminance reduction of the red color light output from the red color pixel located in the logo region.

In example embodiments, the amount of the luminance reduction of the blue color light can increase as a degradation degree of the blue color pixel located in the logo region increases. In addition, the amount of the luminance reduction of the green color light can increase as a degradation degree of the green color pixel located in the logo region increases. Furthermore, the amount of the luminance reduction of the red color light can increase as a degradation degree of the red color pixel located in the logo region increases.

Another aspect is an OLED display comprising a display panel configured to display an image including a logo region, wherein the display panel comprises a plurality of red, green, and blue color pixels; and a display driver configured to: i) drive the display panel and ii) reduce the luminance of blue color light emitted from first blue color pixels located in the logo region.

In example embodiments, the display driver is further configured to determine a logo surrounding region that surrounds the logo region; calculate an average luminance of the blue color light emitted from second blue color pixels located in the logo surrounding region; determine a target luminance of the blue color light emitted from the first blue color pixels based on the average luminance of the blue color light emitted from the second blue color pixels; and reduce the luminance of the blue color light emitted from the first blue color pixels to be substantially the same as the target luminance.

In example embodiments, the display driver is further configured to adjust an amount of reduction in the luminance of the blue color light emitted from the first blue color pixels based on degradation information of the first blue color pixels. The display driver can be further configured to increase the amount of reduction in the luminance of the blue color light emitted from the first blue color pixels as a degree of degradation of the first blue color pixels increases.

In example embodiments, the display driver is further configured to reduce the luminance of green color light emitted from first green color pixels located in the logo region; and reduce the luminance of the first blue color pixels by an amount that is greater than an amount of reduction in the luminance of the first green color pixels.

In example embodiments, the display driver is further configured to determine a logo surrounding region that surrounds the logo region; calculate an average luminance of the blue color light emitted from second blue color pixels located in the logo surrounding region and an average luminance of the green color light emitted from second green color pixels located in the logo surrounding region; determine a blue target luminance of the blue color light emitted from the first blue color pixels and a green target luminance of the green color light emitted from the first green color pixels based on the average luminance of the blue color light emitted from the second blue color pixels and the average luminance of the green color light emitted from the second green color pixels; and reduce the luminance of the blue color light emitted from the first blue color pixels to be substantially the same as the blue target luminance and the luminance of the green color light emitted from the first green color pixels to be substantially the same as the green target luminance.

In example embodiments, the display driver is further configured to adjust the amount of reduction in the luminance of the first blue color pixels based on degradation information of the first blue color pixels; and adjust the amount of reduction in the luminance of the first green color pixels based on degradation information of the first green color pixels. The display driver can be further configured to increase the amount of reduction in the luminance of the first blue color pixels as a degree of degradation of the first blue color pixels increases; and increase the amount of reduction in the luminance of the first green color pixels as a degree of degradation of the first green color pixels increases.

In example embodiments, the display driver is further configured to reduce the luminance of red color light emitted from first red color pixels located in the logo region; and reduce the luminance of the first blue color pixels by an amount that is greater than an amount of reduction in the luminance of the first red color pixels.

In example embodiments, the display driver is further configured to determine a logo surrounding region that surrounds the logo region; calculate an average luminance of the blue color light emitted by second blue color pixels located in the logo surrounding region and an average luminance of the red color light emitted from second red color pixels located in the logo surrounding region; determine a blue target luminance of the blue color light emitted from the first blue color pixels and a target luminance of the red color light emitted from the first red color pixels based on the average luminance of the blue color light emitted from the first blue color pixels and the average luminance of the red color light emitted from the first red color pixels; and reduce the luminance of the blue color light emitted from the first blue color pixels to be substantially the same as the blue target luminance and the luminance of the red color light emitted from the first red color pixels to be substantially the same as the red target luminance.

In example embodiments, the display driver is further configured to adjust the amount of reduction in the luminance of the first blue color pixels based on degradation information of the first blue color pixels, and adjust the amount of reduction in the luminance of the first red color pixels based on degradation information of the first red color pixels. The display driver can be further configured to increase the amount of reduction in the luminance of the first blue color pixels as a degree of degradation of the first blue color pixels increases; and increase the amount of reduction in the luminance of the first red color pixels as a degree of degradation of the first red color pixels increases.

In example embodiments, the display driver is further configured to reduce the luminance of green color light emitted from first green color pixels located in the logo region and luminance of red color light emitted from first red color pixels located in the logo region, reduce the luminance of the first blue color pixels by an amount that is greater than an amount of reduction in the luminance of the first green color pixels and an amount of reduction in the luminance of the first red color pixels, and reduce the luminance of the first green color pixels by an amount that is greater than the amount of reduction in the luminance of the first red color pixels.

In example embodiments, the display driver is further configured to determine a logo surrounding region that surrounds the logo region; calculate i) an average luminance of the blue color light emitted by second blue color pixels located in the logo surrounding region, ii) an average luminance of the green color light emitted by second green color pixels located in the logo surrounding region, and iii) an average luminance of the red color light emitted by second red color pixels located in the logo surrounding region; determine i) a blue target luminance of the blue color light emitted from the first blue color pixels, ii) a green target luminance of the green color light emitted from the first green color pixels, and iii) a red target luminance of the red color light emitted from the first red color pixels based on the average luminance of the blue color light emitted from the first blue color pixels, the average luminance of the green color light emitted from the first blue color pixels, and the average luminance of the red color light emitted from the first blue color pixels; and reduce i) the luminance of the blue color light emitted from the first blue color pixels to be substantially the same as the blue target luminance, ii) the luminance of the green color light emitted from the first green color pixels to be substantially the same as the green target luminance, and iii) the luminance of the red color light emitted from the first red color pixels to be substantially the same as the red target luminance.

In example embodiments, the display driver is further configured to adjust the amount of reduction in the luminance of the first blue color pixels based on degradation information of the first blue color pixels; adjust the amount of reduction in the luminance of the first green color pixels based on degradation information of the first green color pixels; and adjust the amount of reduction in the luminance of the first red color pixels based on degradation information of the first red color pixels.

In example embodiments, the display driver is further configured to increase the amount of reduction in the luminance of the first blue color pixels as a degree of degradation of the first blue color pixels increases; increase the amount of reduction in the luminance of the first green color pixels as a degree of degradation of the first green color pixels increases; and increase the amount of reduction in the luminance of the first red color pixels as a degree of degradation of the first red color pixels increases.

In example embodiments, the display driver is further configured to a scan driver configured to provide a plurality of scan signals to the display panel; a data driver configured to provide a plurality of data signals to the display panel; a logo controller configured to generate compensated image data by reducing the luminance of the logo region on initial image data; and a timing controller configured to control the scan driver, the data driver, and the logo controller. The display driver can be further configured to a memory configured to store degradation information of each of the first blue, green, and red color pixels.

Another aspect is a method of adjusting the luminance of a logo region of an image for display by an OLED display, the method comprising detecting a logo region of the image that is displayed on the OLED display; determining a logo surrounding region display on the OLED display that surrounds the logo region; calculating i) an average luminance of blue color light emitted by second blue color pixels located in the logo surrounding region, ii) an average luminance of green color light emitted by second green color pixels located in the logo surrounding region, and iii) an average luminance of red color light emitted by second red color pixels located in the logo surrounding region; determining i) a blue target luminance of blue color light emitted by first blue color pixels located in the logo region, ii) a green target luminance of green color light emitted by first green color pixels located in the logo region, and iii) a red target luminance of red color light emitted by first red color pixels located in the logo region based on the average luminance of the blue color light emitted by the second blue color pixels, the average luminance of the green color light emitted by the second green color pixels, and the average luminance of the red color light emitted by the second blue color pixels; and reducing i) the luminance of the blue color light emitted by the first blue color pixels to be substantially the same as the blue target luminance, ii) the luminance of the green color light emitted by the first green color pixels to be substantially the same as the green target luminance, and iii) the luminance of the red color light emitted by the first red color pixels to be substantially the same as the red target luminance, wherein an amount of reduction in luminance of the blue color light emitted by the first blue color pixels is determined to be greater than an amount of reduction in luminance of the green color light emitted by the first green color pixels and an amount of reduction in luminance of the red color light emitted by the first red color pixels, and wherein the amount of reduction in the luminance of the green color light emitted by the first green color pixels is determined to be greater than the amount of reduction in the luminance of the red color light emitted by the first red color pixels.

In example embodiments, the amount of reduction in the luminance of the blue color light emitted by the first blue color pixels increases as a degree of degradation of the first blue color pixels increases, wherein the amount of reduction in the luminance of the first green color pixels increases as a degree of degradation of the first green color pixels increases, and wherein the amount of reduction in the luminance of the first red color pixels increases as a degree of degradation of the first red color pixels increases.

Therefore, an OLED display according to at least one example embodiment can efficiently reflect pixel characteristics related to a lifetime of a display panel by preferentially reducing luminance of light (e.g., blue color light) that is output from a pixel that is vulnerable to degradation (e.g., blue color pixel) and by additionally adjusting an amount of luminance reduction of light based on degradation information of respective pixels when the OLED display reduces luminance of a logo region of an image displayed on the display panel to alleviate a permanent afterimage due to a luminance difference or a color difference between the logo region of the image and a non-logo region of the image.

In addition, according to at least one embodiment, a method of adjusting luminance of a logo region of an image for an OLED display can efficiently reflect pixel characteristics related to a lifetime of a display panel included in the OLED display by preferentially reducing luminance of light (e.g., blue color light) that is output from a pixel that is vulnerable to degradation (e.g., blue color pixel) and by additionally adjusting an amount of luminance reduction of light based on degradation information of respective pixels.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating an OLED display according to example embodiments.

FIG. 2 is a block diagram illustrating an example of a display driving integrated circuit included in the OLED display of FIG. 1.

FIG. 3 is a block diagram illustrating another example of a display driving integrated circuit included in the OLED display of FIG. 1.

FIG. 4 is a diagram illustrating an image that is displayed on a display panel included in the OLED display of FIG. 1.

FIG. 5 is a flowchart illustrating a method of adjusting luminance of a logo region of an image for an OLED display according to example embodiments.

FIG. 6 is a diagram illustrating an example in which target luminance for respective pixels located in a logo region of an image is determined by the method of FIG. 5.

FIG. 7 is a graph illustrating a lifetime characteristic of respective pixels included in an OLED display employing the method of FIG. 5.

FIG. 8 is a flowchart illustrating a method of adjusting luminance of a logo region of an image for an OLED display according to example embodiments.

FIG. 9 is a flowchart illustrating an example in which the method of FIG. 8 adjusts luminance of a logo region of an image by reflecting degradation information of respective pixels.

FIG. 10 is a diagram illustrating an example in which target luminance for respective pixels located in a logo region of an image is determined by the method of FIG. 8.

FIG. 11 is a block diagram illustrating an electronic device according to example embodiments.

FIG. 12 is a diagram illustrating an example in which the electronic device of FIG. 11 is implemented as a television.

### DETAILED DESCRIPTION OF CERTAIN INVENTIVE EMBODIMENTS

Generally, when an image displayed on a display panel includes a logo included in a logo region, the logo region has a relatively high gray-scale (e.g., implements a relatively high luminance) compared to a non-logo region of the image. Thus, the logo region of the image may cause increased pixel degradation when compared to the non-logo region of the image. As a result, the difference between the pixel degradation in the logo region and the pixel degradation in the non-logo region of the image increases with the length of time that the logo region is displayed. Thus, a permanent afterimage may be formed due to a luminance or color difference between the logo region and the non-logo region of the image. This permanent afterimage is observable by a viewer.

To prevent a permanent afterimage from forming, the standard OLED display reduces the luminance of the logo region based on the average luminance of a region that surrounds the logo region. However, this technique may not properly take into account the differing effects on the lifetime of applying current to different color pixels.

Hereinafter, the described technology will be explained in detail with reference to the accompanying drawings.

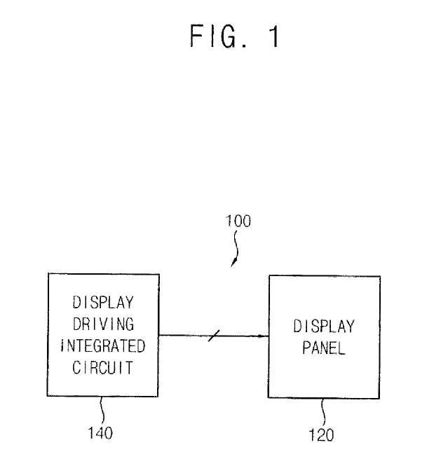

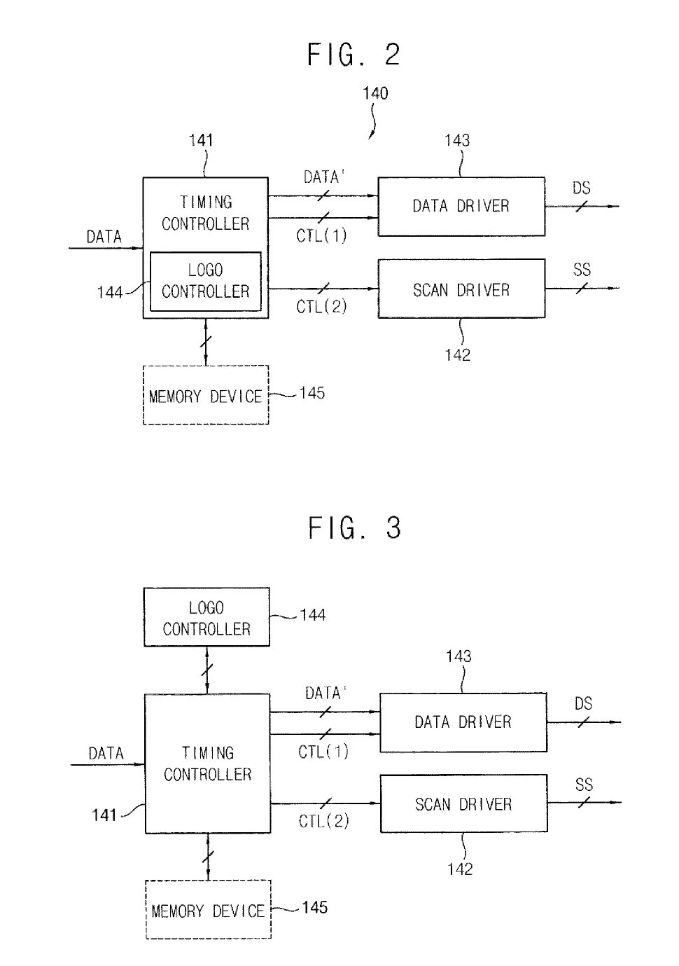

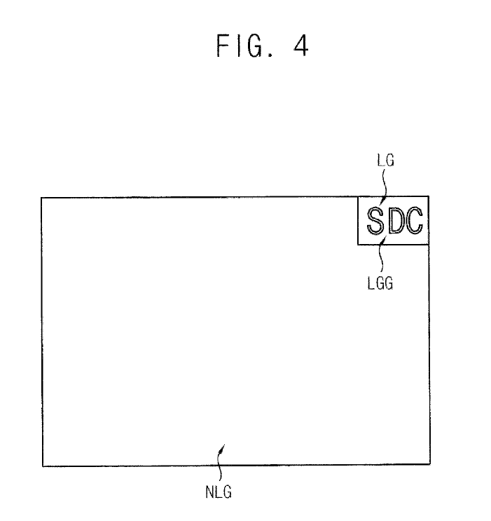

FIG. 1 is a block diagram illustrating an OLED display according to example embodiments. Depending on embodiments, certain elements may be removed from or additional elements may be added to the OLED display 100 illustrated in FIG. 1. Furthermore, two or more elements may be combined into a single element, or a single element may be realized as multiple elements. This applies to the remaining apparatus embodiments. FIG. 2 is a block diagram illustrating an example of a display driving integrated circuit included in the OLED display of FIG. 1. FIG. 3 is a block diagram illustrating another example of a display driving integrated circuit included in the OLED display of FIG. 1. FIG. 4 is a diagram illustrating an image that is displayed on a display panel included in the OLED display of FIG. 1.

Referring to FIGS. 1 through 4, the OLED display 100 includes a display panel 120 that displays an image and a display driving integrated circuit or display driver 140 that drives the display panel 120. In addition, as illustrated in FIGS. 2 and 3, the display driving integrated circuit 140 includes a timing controller 141, a scan driver 142, a data driver 143, and a logo controller 144. Furthermore, the display driving integrated circuit 140 may include a memory device 145. In some example embodiments, the OLED display 100 further include other components (e.g., a power supply that provides a high power voltage ELVDD and a low power voltage ELVSS to the display panel 120, etc.).

The display panel 120 includes a plurality of pixels. The display panel 120 is connected to the scan driver 142 of the display driving integrated circuit 140 via first through (n)th scan-lines, where n is an integer greater than or equal to 2. The display panel 120 is connected to the data driver 143 of the display driving integrated circuit 140 via first through (m)th data-lines, where m is an integer greater than or equal to 2. Here, since the pixels are arranged at locations corresponding to the intersections between the first through (n)th scan-lines and the first through (m)th data-lines, the display panel 120 includes n×m pixels.

The display panel 120 may include a red color pixel that outputs red color light, a green color pixel that outputs green color light, and a blue color pixel that outputs blue color light. The display panel 120 can display an image based on the red, green, and blue color light output from the red, green, and blue color pixels. In some embodiments, the display panel 120 further includes a white color pixel that outputs white color light. In these embodiments, one of each of the red, blue, green and white color pixels (or sub-pixels) can form a single pixel that can emit light having a color that is a combination of the colors of light emitted from each of the sub-pixels.

In example embodiments, as illustrated in FIG. 4, an image including a logo region LG is displayed on the display panel 120. Generally, the logo region LG of the image is continuously displayed at a specific location within the image for a relatively long period of time. For example, the logo region LG of the image may include a subtitle, a character string, a figure, etc. For example, the logo region LG of the image may indicate the source of the image (e.g., CNN, KBS, MBC, etc.). In addition, a non-logo region LGG and NLG of the image may include a logo surrounding region LGG of the image that surrounds the logo region LG of the image. Here, the logo surrounding region LGG of the image may be determined in various ways according to requirements for reducing luminance of the logo region LG of the image.

Due to the nature of the logo region LG of the image, the logo region LG of the image may overwhelm (e.g., have a substantially greater gray-level than) the non-logo region LGG and NLG of the image to be effectively observed or perceived by a viewer. Thus, the logo region LG of the image can have a relatively high gray-scale (i.e., implements relatively high luminance) compared to the non-logo region LGG and NLG of the image, so that the logo region LG of the image may cause pixel degradation faster than the non-logo region LGG and NLG of the image. As a result, the difference between the pixel degradation due to the logo region LG of the image and the pixel degradation due to the non-logo region LGG and NLG of the image increases as the OLED display 100 displays the logo region LG. Thus, a permanent afterimage caused due to a luminance difference or a color difference between the logo region LG of the image and the non-logo region LGG and NLG of the image may be observed by the viewer as the OLED display 100 displays the logo region LG. To overcome this problem, the display driving integrated circuit 140 can slow or alleviate the degradation of pixels located in the logo region LG of the image by reducing the luminance of the logo region LG of the image. Thus, the lifetime of the display panel 120 can be improved.

In an example embodiment, the display driving integrated circuit 140 can reduce the luminance of the logo region LG of the image by reducing the luminance of the blue color light output from the blue color pixels located in the logo region LG of the image. Specifically, the display driving integrated circuit 140 can determine the logo surrounding region LGG of the image that surrounds the logo region LG of the image by detecting the logo region LG of the image and calculate the average luminance of the blue color light of the logo surrounding region LGG of the image. The display driving integrated circuit 140 can further determine a target luminance of the blue color light for reducing the luminance of the logo region LG of the image based on the average luminance of the blue color light of the logo surrounding region LGG of the image and reduce the luminance of the blue color light of the logo region LG of the image to be substantially the same as the target luminance of the blue color light.

Generally, in an OLED display, blue color pixels are required to control a relatively large amount of current to flow through the OLED to implement a specific luminance compared to red and green color pixels. Thus, under substantially the same conditions, the OLED included in a blue color pixel may be degraded faster than the OLEDs included in red or green color pixels. As a result, the lifetime of the blue color pixels may be shorter than the lifetimes of the red and green color pixels. For this reason, in order to increase the lifetime of the display panel 120, the display driving integrated circuit 140 can preferentially reduce the luminance of the blue color light output from the blue color pixels, that are vulnerable to degradation, when the display driving integrated circuit 140 reduces the luminance of the logo region LG of the image.

The color of the logo region LG of the image may be changed as the luminance of the blue color light is reduced. However, since the luminance of the logo region LG of the image is changed (i.e., reduced) to be closer to the luminance of the logo surrounding region LGG of the image, the viewer cannot easily observe or perceive a color change in the logo region LG of the image. In some example embodiments, the display driving integrated circuit 140 can adjust the amount of reduction in luminance of the blue color light based on degradation information of the blue color pixels located in the logo region LG of the image. Specifically, the display driving integrated circuit 140 can increase the amount of reduction in the luminance of the blue color light as the degree of degradation of the blue color pixels located in the logo region LG of the image increases. In other words, the display driving integrated circuit 140 can slow the degradation of the blue color pixels by increasing the amount of reduction in the luminance of the blue color light when the degree of degradation of the blue color pixel is relatively high.

In another example embodiment, the display driving integrated circuit 140 can reduce the luminance of the logo region LG of the image by reducing the luminance of the blue color light output from the blue color pixels located in the logo region LG of the image and the luminance of the green color light output from the green color pixel located in the logo region LG of the image. Specifically, the display driving integrated circuit 140 can determine the logo surrounding region LGG of the image that surrounds the logo region LG of the image by detecting the logo region LG of the image and calculate the average luminance of the blue color light of the logo surrounding region LGG of the image and the average luminance of the green color light of the logo surrounding region LGG of the image. The display driving integrated circuit 140 can also determine a target luminance of the blue color light and a target luminance of the green color light for reducing the luminance of the logo region LG of the image based on the average luminance of the blue color light of the logo surrounding region LGG of the image and the average luminance of the green color light of the logo surrounding region LGG of the image and reduce the luminance of the blue color light of the logo region LG of the image to be substantially the same as the target luminance of the blue color light and the luminance of the green color light of the logo region LG of the image to be substantially the same as the target luminance of the green color light.

In order to lengthen the lifetime of the display panel 120, the display driving integrated circuit 140 can preferentially reduce the luminance of the blue color light output from the blue color pixels, that are vulnerable to degradation, when the display driving integrated circuit 140 reduces the luminance of the logo region LG of the image. That is, since the OLEDs included in the blue color pixels are degraded faster than the OLEDs included in the green color pixels under substantially the same conditions (i.e., since the lifetime of blue color pixels is shorter than the lifetime of green color pixels), the display driving integrated circuit 140 can control the amount of reduction in the luminance of the blue color light output from the blue color pixels located in the logo region LG of the image to be greater than the amount of reduction in the luminance of the green color light output from the green color pixels located in the logo region LG of the image.

Here, the color of the logo region LG of the image may be changed as the luminance of the blue color light and the luminance of the green color light are reduced. However, since the luminance of the logo region LG of the image is changed (e.g., reduced) to be closer to the luminance of the logo surrounding region LGG of the image, the viewer cannot easily observe the color change of the logo region LG of the image. In some example embodiments, the display driving integrated circuit 140 can adjust the amount of reduction in the luminance of the blue color light based on the degradation information of the blue color pixels located in the logo region LG of the image and can adjust the amount of reduction in the luminance of the green color light based on the degradation information of the green color pixels located in the logo region LG of the image.

Specifically, the display driving integrated circuit 140 can increase the amount of reduction in the luminance of the blue color light as the degree of degradation of the blue color pixels located in the logo region LG of the image increases and increase an amount of reduction in the luminance of the green color light as the degree of degradation of the green color pixels located in the logo region LG of the image increases. In other words, the display driving integrated circuit 140 can slow the degradation of the blue color pixels by increasing the amount of reduction in the luminance of the blue color light when the degree of degradation of the blue color pixel is relatively high and can slow the degradation of the green color pixels by increasing the amount of reduction in the luminance of the green color light when the degree of degradation of the green color pixels is relatively high.

In still another example embodiment, the display driving integrated circuit 140 can reduce the luminance of the logo region LG of the image by reducing the luminance of the blue color light output from the blue color pixels located in the logo region LG of the image and the luminance of the red color light output from the red color pixels located in the logo region LG of the image. Specifically, the display driving integrated circuit 140 can determine the logo surrounding region LGG of the image that surrounds the logo region LG of the image by detecting the logo region LG of the image and calculate the average luminance of the blue color light of the logo surrounding region LGG of the image and the average luminance of the red color light of the logo surrounding region LGG of the image. The display driving integrated circuit 140 can also determine a target luminance of the blue color light and a target luminance of the red color light for reducing the luminance of the logo region LG of the image based on the average luminance of the blue color light of the logo surrounding region LGG of the image and the average luminance of the red color light of the logo surrounding region LGG of the image and reduce the luminance of the blue color light of the logo region LG of the image to be substantially the same as the target luminance of the blue color light and the luminance of the red color light of the logo region LG of the image to be substantially the same as the target luminance of the red color light.

In order to lengthen the lifetime of the display panel 120, the display driving integrated circuit 140 can preferentially reduce the luminance of the blue color light output from the blue color pixels, that are vulnerable to degradation, when the display driving integrated circuit 140 reduces the luminance of the logo region LG of the image. That is, since the OLEDs included in the blue color pixels are degraded faster than the OLEDs included in the red color pixels under substantially the same conditions (i.e., since the lifetime of the blue color pixels is shorter than the lifetime of the red color pixels), the display driving integrated circuit 140 can control the amount of reduction in the luminance of the blue color light output from the blue color pixels located in the logo region LG of the image to be greater than the amount of reduction in the luminance of the red color light output from the red color pixels located in the logo region LG of the image.

The color of the logo region LG of the image may be changed as the luminance of the blue color light and the luminance of the red color light are reduced. However, since the luminance of the logo region LG of the image is changed (e.g., reduced) to be closer to the luminance of the logo surrounding region LGG of the image, the viewer cannot easily observe the color change of the logo region LG of the image. In some example embodiments, the display driving integrated circuit 140 can adjust the amount of reduction in the luminance of the blue color light based on the degradation information of the blue color pixels located in the logo region LG of the image and adjust the amount of reduction in the luminance of the red color light based on the degradation information of the red color pixels located in the logo region LG of the image.

Specifically, the display driving integrated circuit 140 can increase the amount of reduction in the luminance of the blue color light as the degree of degradation of the blue color pixels located in the logo region LG of the image increases and increase the amount of reduction in the luminance of the red color light as the degree of degradation of the red color pixels located in the logo region LG of the image increases. In other words, the display driving integrated circuit 140 can slow the degradation of the blue color pixel by increasing an amount of reduction in the luminance of the blue color light when the degree of degradation of the blue color pixels is relatively high and slow the degradation of the red color pixel by increasing an amount of reduction in the luminance of the red color light when the degree of degradation of the red color pixel is relatively high.

In still another example embodiment, the display driving integrated circuit 140 can reduce the luminance of the logo region LG of the image by reducing the luminance of the blue color light output from the blue color pixels located in the logo region LG of the image, the luminance of the green color light output from the green color pixels located in the logo region LG of the image, and the luminance of the red color light output from the red color pixels located in the logo region LG of the image. Specifically, the display driving integrated circuit 140 can determine the logo surrounding region LGG of the image that surrounds the logo region LG of the image by detecting the logo region LG of the image and calculate the average luminance of the blue color light of the logo surrounding region LGG of the image, the average luminance of the green color light of the logo surrounding region LGG of the image, and the average luminance of the red color light of the logo surrounding region LGG of the image. The display driving integrated circuit 140 can also determine a target luminance of the blue color light, a target luminance of the green color light, and a target luminance of the red color light for reducing the luminance of the logo region LG of the image based on the average luminance of the blue color light of the logo surrounding region LGG of the image, the average luminance of the green color light of the logo surrounding region LGG of the image, and the average luminance of the red color light of the logo surrounding region LGG of the image. The display driving integrated circuit 140 can further reduce the luminance of the blue color light of the logo region LG of the image to be substantially the same as the target luminance of the blue color light, the luminance of the green color light of the logo region LG of the image to be substantially the same as the target luminance of the green color light, and the luminance of the red color light of the logo region LG of the image to be substantially the same as the target luminance of the red color light.

In order to lengthen the lifetime of the display panel 120, the display driving integrated circuit 140 can preferentially reduce the luminance of the blue color light output from the blue color pixels, that are vulnerable to degradation, when the display driving integrated circuit 140 reduces the luminance of the logo region LG of the image. That is, since the OLEDs included in the blue color pixels are degraded faster than the OLEDs included in the green and red color pixels, under substantially the same conditions (i.e., since the lifetime of the blue color pixels is shorter than the lifetime of the green and red color pixels), the display driving integrated circuit 140 can control an amount of reduction in the luminance of the blue color light output from the blue color pixels located in the logo region LG of the image to be greater than an amount of reduction in the luminance of the green color light output from the green color pixel located in the logo region LG of the image and an amount of reduction in the luminance of the red color light output from the red color pixel located in the logo region LG of the image.

In addition, since the OLEDs included in the green color pixels are degraded faster than the OLEDs included in the red color pixels under substantially the same conditions (i.e., since the lifetime of the green color pixels is shorter than the lifetime of the red color pixels), the display driving integrated circuit 140 can control an amount of reduction in the luminance of the green color light output from the green color pixels located in the logo region LG of the image to be greater than an amount of reduction in the luminance of the red color light output from the red color pixels located in the logo region LG of the image.

Here, the color of the logo region LG of the image may be changed as the luminance of the blue color light, the luminance of the green color light, and the luminance of the red color light are reduced. However, since the luminance of the logo region LG of the image is changed (e.g., reduced) to be closer to the luminance of the logo surrounding region LGG of the image, the viewer cannot easily observe the color change of the logo region LG of the image. In some example embodiments, the display driving integrated circuit 140 can adjust an amount of reduction in the luminance of the blue color light based on the degradation information of the blue color pixels located in the logo region LG of the image, adjust an amount of reduction in the luminance of the green color light based on the degradation information of the green color pixels located in the logo region LG of the image, and adjust an amount of reduction in the luminance of the red color light based on the degradation information of the red color pixels located in the logo region LG of the image.

Specifically, the display driving integrated circuit 140 can increase an amount of reduction in the luminance of the blue color light as the degree of degradation of the blue color pixel located in the logo region LG of the image increases, increase an amount of reduction in the luminance of the green color light as the degree of degradation of the green color pixels located in the logo region LG of the image increases, and increase an amount of reduction in the luminance of the red color light as the degree of degradation of the red color pixels located in the logo region LG of the image increases. In other words, the display driving integrated circuit 140 can slow the degradation of the blue color pixels by increasing an amount of reduction in the luminance of the blue color light when the degree of degradation of the blue color pixels is relatively high, slow the degradation of the green color pixels by increasing an amount of reduction in the luminance of the green color light when the degree of degradation of the green color pixels is relatively high, and slow the degradation of the red color pixels by increasing an amount of reduction in the luminance of the red color light when the degree of degradation of the red color pixels is relatively high.

As described above, the display driving integrated circuit 140 can slow or alleviate the degradation of the pixels located in the logo region LG of the image by reducing the luminance of the logo region LG of the image. In order to implement this slowing or alleviation of the degradation of the pixels, the display driving integrated circuit 140 can include the timing controller 141, the scan driver 142, the data driver 143, and the logo controller 144. The scan driver 142 provides a scan signal SS to the display panel 120 via the scan-lines. The data driver 143 provides a data signal DS to the display panel 120 via the data-lines.

The logo controller 144 can perform the above-described operations for reducing the luminance of the logo region LG of the image. That is, the logo controller 144 can generate compensated image data DATA′ by reducing the luminance of the logo region LG of the image on image data DATA received from an external source. The timing controller 141 can generate control signals CTL(1) and CTL(2) and provide the control signals CTL(1) and CTL(2) to the data driver 143 and the scan driver 142. That is, the timing controller 141 can control the data driver 143 and the scan driver 142. In addition, the timing controller 141 can control the logo controller 144.

The timing controller 141 can interact with the logo controller 141 to change the image data DATA to the compensated image data DATA′. In an example embodiment, as illustrated in FIG. 2, the logo controller 144 can be located inside the timing controller 141. In another example embodiment, as illustrated in FIG. 3, the logo controller 144 can be located outside of the timing controller 141. That is, the logo controller 144 can be implemented separately from the timing controller 141. In some example embodiments, the display driving integrated circuit 140 further includes the memory device 145 (e.g., a flash memory device, an EEPROM device, etc.) that stores the degradation information of the blue color pixel, the degradation information of the green color pixel, and the degradation information of the red color pixel by accumulating the image data DATA applied to the blue color pixel, the green color pixel, and the red color pixel included in the display panel 120.

In other words, when the OLED display 100 operates (i.e., when the display panel 120 is turned on), the image data DATA applied to the blue color pixel, the green color pixel, and the red color pixel can be accumulated and stored in the memory device 145. As described above, the degradation information of the blue color pixel can indicate the degree of degradation of the blue color pixel, the degradation information of the green color pixel can indicate the degree of degradation of the green color pixel, and the degradation information of the red color pixel can indicate the degree of degradation of the red color pixel. Therefore, the display driving integrated circuit 140 can adjust an amount of reduction in the luminance of the blue color light, an amount of reduction in the luminance of the green color light, and/or an amount of reduction in the luminance of the red color light based on the degradation information of the blue color pixel, the degradation information of the green color pixel, and/or the degradation information of the red color pixel that are stored in the memory device 145.

In brief, the OLED display 100 can efficiently reflect pixel characteristics related to the lifetime of the display panel 120 by preferentially reducing the luminance of the light (e.g., the blue color light) that is output from the pixel(s) that are vulnerable to degradation (e.g., the blue color pixel) and by additionally adjusting an amount of reduction in the luminance of the light based on the degradation information of respective pixels when the OLED display 100 reduces the luminance of the logo region LG of the image displayed on the display panel 120 to alleviate the permanent afterimage caused due to the luminance difference or the color difference between the logo region LG of the image and the non-logo region NLG of the image.

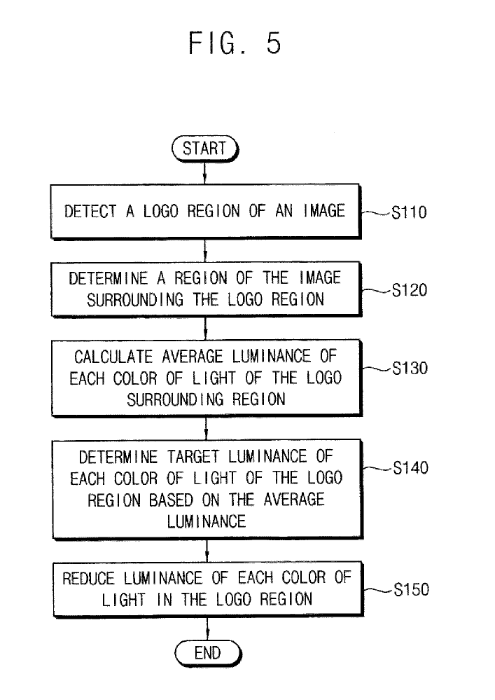

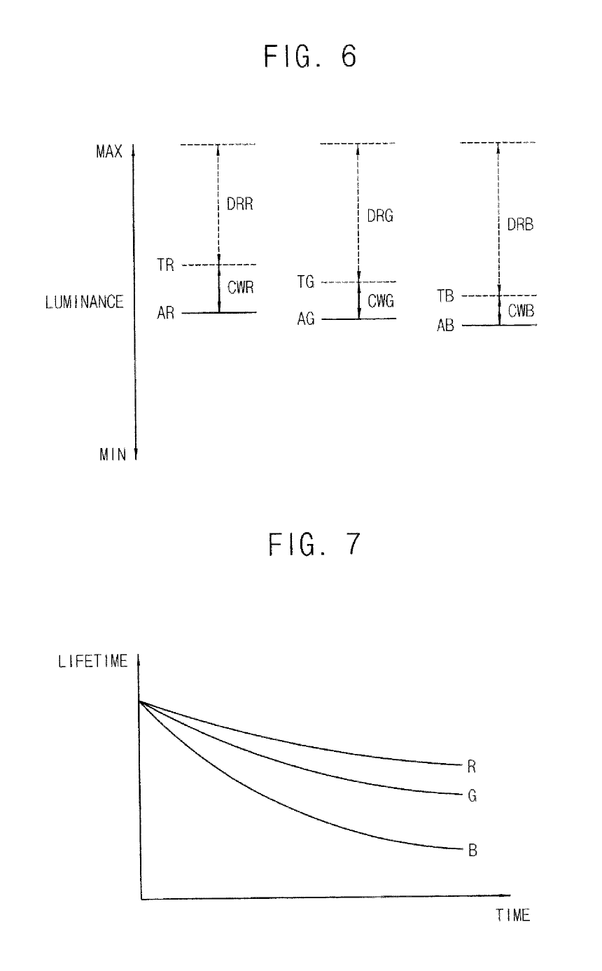

FIG. 5 is a flowchart illustrating a method of adjusting luminance of a logo region of an image for an OLED display according to example embodiments. Depending on embodiments, additional states may be added, others removed, or the order of the states changed in the procedure of FIG. 5. This applies to the remaining method embodiments. FIG. 6 is a diagram illustrating an example in which target luminance for respective pixels located in a logo region of an image is determined by the method of FIG. 5. FIG. 7 is a graph illustrating a lifetime characteristic of respective pixels included in an OLED display employing the method of FIG. 5.

Referring to FIGS. 5 through 7, the method of FIG. 5 includes detecting a logo region of an image displayed on a display panel (S110). The method also includes determining a region of the image surrounding the logo region, also referred to as a logo surrounding region (S120). The method further includes calculating the average luminance AR of red color light of the logo surrounding region of the image, the average luminance AG of green color light of the logo surrounding region of the image, and the average luminance AB of blue color light of the logo surrounding region of the image (S130). Subsequently, the method of FIG. 5 includes determining a target luminance TR of the red color light, a target luminance TG of the green color light, and a target luminance TB of the blue color light for reducing the luminance of the logo region of the image based on the average luminance AR of the red color light of the logo surrounding region, the average luminance AG of the green color light of the logo surrounding region, and the average luminance AB of the blue color light of the logo surrounding region (S140). Next, the method of FIG. 5 includes reducing the luminance of the red color light of the logo region of the image to be substantially the same as the target luminance TR of the red color light, the luminance of the green color light of the logo region of the image to be substantially the same as the target luminance TG of the green color light, and the luminance of the blue color light of the logo region of the image to be substantially the same as the target luminance TB of the blue color light (S150).

As illustrated in FIG. 7, under substantially the same conditions, the OLEDs included in the blue color pixels B are degraded faster than the OLEDs included in the red color pixels R and the OLEDs included in the green color pixels G. Similarly, the OLEDs included in the green color pixels G are degraded faster than the OLEDs included in the red color pixels R. Thus, the lifetime of the blue color pixels B is shorter than the lifetime of the red color pixels R and the lifetime of the green color pixels G. The lifetime of the green color pixels G is shorter than the lifetime of the red color pixels R. For this reason, as illustrated in FIG. 6, the method of FIG. 5 can control an amount of reduction in the luminance of the blue color light output from the blue color pixels B located in the logo region of the image to be greater than an amount of reduction in the luminance of the green color light output from the green color pixels G located in the logo region of the image and an amount of reduction in the luminance of the red color light output from the red color pixels R located in the logo region of the image. The method of FIG. 5 can also control an amount of reduction in the luminance of the green color light output from the green color pixels G located in the logo region of the image to be greater than an amount of reduction in the luminance of the red color light output from the red color pixels R located in the logo region of the image.

Here, an amount of reduction in the luminance of the blue color light, an amount of reduction in the luminance of the green color light, and an amount of reduction in the luminance of the red color light are not absolute but are relative. In other words, an amount of reduction in the luminance of the blue color light, an amount of reduction in the luminance of the green color light, and an amount of reduction in the luminance of the red color light may differ from each other as long as a color change of the logo region of the image is within a predetermined range (e.g., minimized).

For example, for the red color pixel R, since a difference CWR between the target luminance TR of the red color light of the logo region of the image and the average luminance AR of the red color light of the logo surrounding region of the image is relatively large, an amount of reduction in the luminance of the red color light may be relatively small (i.e., indicated as a luminance reduction range DRR) when the luminance of the red color light of the logo region of the image is reduced to be substantially the same as the target luminance TR of the red color light. In addition, for the green color pixel G, since a difference CWG between the target luminance TG of the green color light of the logo region of the image and the average luminance AG of the green color light of the logo surrounding region of the image is less than the difference CWR between the target luminance TR of the red color light of the logo region of the image and the average luminance AR of the red color light of the logo surrounding region of the image, an amount of reduction in the luminance of the green color light may be greater than an amount of reduction in the luminance of the red color light (i.e., indicated as a luminance reduction range DRG). Furthermore, for the blue color pixel B, since a difference CWB between the target luminance TB of the blue color light of the logo region of the image and the average luminance AB of the blue color light of the logo surrounding region of the image is relatively small, an amount of reduction in the luminance of the blue color light may be relatively large (i.e., indicated as a luminance reduction range DRB) when the luminance of the blue color light of the logo region of the image is reduced to be substantially the same as the target luminance TB of the blue color light.

Although it is illustrated in FIG. 6 that the target luminance TR of the red color light, the target luminance TG of the green color light, and the target luminance TB of the blue color light are determined to be respectively greater than the average luminance AR of the red color light, the average luminance AG of the green color light, and the average luminance AB of the blue color light, the determination of the target luminance TR, TG, and TB is not limited thereto. For example, the target luminance TR of the red color light, the target luminance TG of the green color light, and the target luminance TB of the blue color light may be determined to be respectively less than the average luminance AR of the red color light, the average luminance AG of the green color light, and the average luminance AB of the blue color light. In this embodiment, it should be understood that an amount of reduction in the luminance of the light increases as a difference CWR, CWG, and CWB between the target luminance TR, TG, and TB of the logo region of the image and the average luminance AR, AG, and AB of the logo surrounding region of the image increases.

In brief, the method of FIG. 5 can efficiently reflect pixel characteristics related to the lifetime of the display panel by preferentially reducing the luminance of the light (e.g., the blue color light) that is output from the pixels that are vulnerable to degradation (e.g., the blue color pixel) when the method of FIG. 5 reduces the luminance of the logo region of the image displayed on the display panel to alleviate the permanent afterimage due to the luminance difference or the color difference between the logo region of the image and the non-logo region of the image.

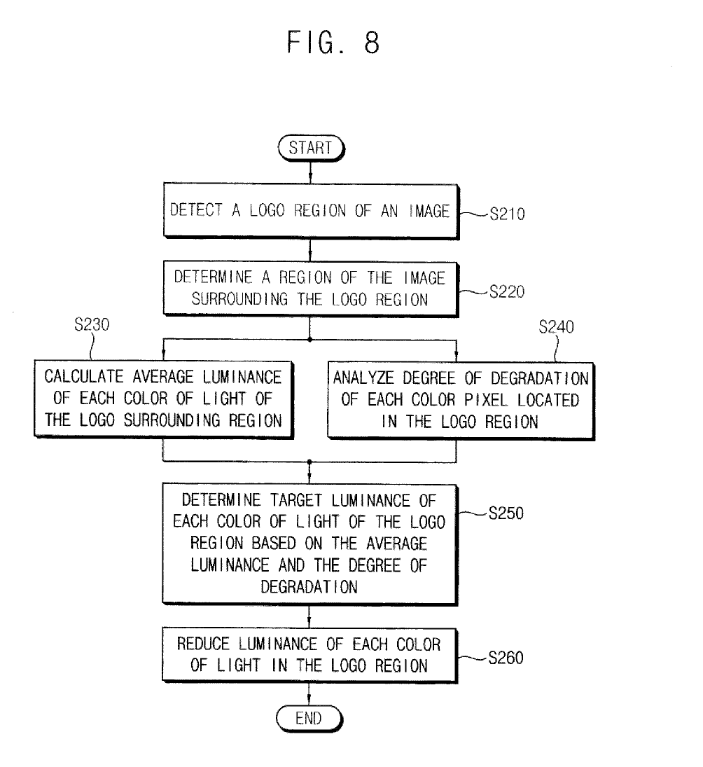

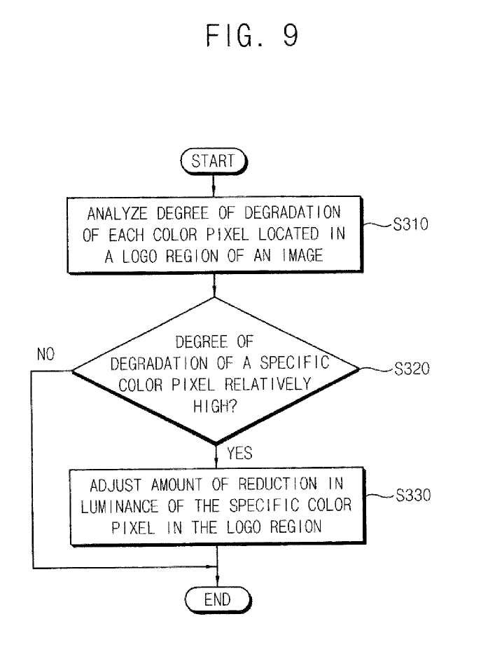

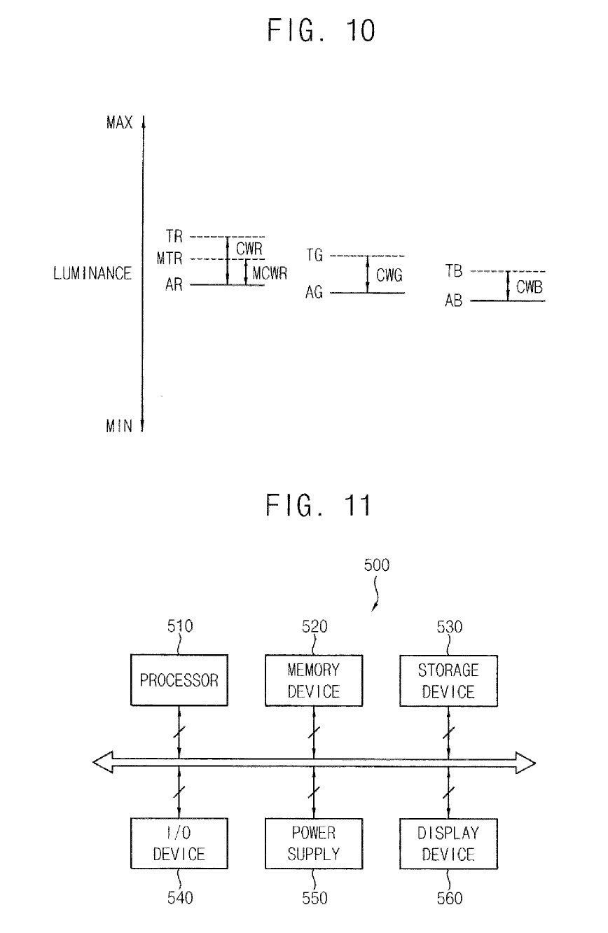

FIG. 8 is a flowchart illustrating a method of adjusting luminance of a logo region of an image for an OLED display according to example embodiments. FIG. 9 is a flowchart illustrating an example in which the method of FIG. 8 adjusts luminance of a logo region of an image by reflecting degradation information of respective pixels. FIG. 10 is a diagram illustrating an example in which target luminance for respective pixels located in a logo region of an image is determined by the method of FIG. 8.

Referring to FIGS. 8 through 10, the method of FIG. 8 includes detecting a logo region of an image displayed on a display panel (S210) and determining a logo surrounding region of the image that surrounds the logo region of the image (S220). The method also includes calculating an average luminance AR of red color light of the logo surrounding region of the image, an average luminance AG of green color light of the logo surrounding region of the image, and an average luminance AB of blue color light of the logo surrounding region of the image (S230). The method further includes analyzing a degree of degradation or an amount of degradation of a red color pixel located in the logo region of the image, a degree of degradation of a green color pixel located in the logo region of the image, and a degree of degradation of a blue color pixel located in the logo region of the image (S240). Subsequently, the method of FIG. 8 includes determining a target luminance TR of the red color light, a target luminance TG of the green color light, and a target luminance TB of the blue color light for reducing the luminance of the logo region of the image based on the average luminance AR of the red color light of the logo surrounding region of the image, the average luminance AG of the green color light of the logo surrounding region of the image, the average luminance AB of the blue color light of the logo surrounding region of the image, the degree of degradation of the red color pixel located in the logo region of the image, the degree of degradation of the green color pixel located in the logo region of the image, and the degree of degradation of the blue color pixel located in the logo region of the image (S250).

Next, the method of FIG. 8 includes reducing the luminance of the red color light of the logo region of the image to be substantially the same as the target luminance TR of the red color light, the luminance of the green color light of the logo region of the image to be substantially the same as the target luminance TG of the green color light, and the luminance of the blue color light of the logo region of the image to be substantially the same as the target luminance TB of the blue color light (S260). In some example embodiments, the method of FIG. 8 includes adjusts luminance of a logo region of an image by reflecting degradation information of respective pixels as shown in FIG. 9.

The method of FIG. 9 includes analyzing the degree of degradation of the red color pixel located in the logo region of the image, the degree of degradation of the green color pixel located in the logo region of the image, and the degree of degradation of the blue color pixel located in the logo region of the image (S310) and determining whether a degree of degradation of a specific color pixel (e.g., a blue color pixel) is greater than those of other color pixels in the logo region of the image (S320). Here, when the degree of degradation of the specific color pixel is greater than those of other color pixels in the logo region of the image, the method of FIG. 8 includes adjusting an amount of reduction in luminance of the specific color pixel in the logo region of the image (S330). On the other hand, when the degree of degradation of the specific color pixel is not greater than those of other color pixels in the logo region of the image, the method of FIG. 8 does not adjust an amount of reduction in the luminance of the specific color pixel in the logo region of the image. In this way, the method of FIG. 8 can further adjust the luminance of the logo region of the image by reflecting the degradation information of respective pixels located in the logo region of the image.

As described above, under substantially the same conditions, the OLEDs included in the blue color pixels may be degraded faster than the OLEDs included in the red and green color pixels. In addition, under substantially the same conditions, the OLEDs included in the green color pixels may be degraded faster than the OLEDs included in the red color pixels. Thus, the lifetime of the blue color pixels may be shorter than the lifetime of the green and red color pixels and the lifetime of the green color pixels may be shorter than the lifetime of the red color pixels.

For this reason, the method of FIG. 8 can control an amount of reduction in the luminance of the blue color light output from the blue color pixels located in the logo region of the image to be greater than an amount of reduction in the luminance of the green color light output from the green color pixels located in the logo region of the image and an amount of reduction in the luminance of the red color light output from the red color pixel located in the logo region of the image. In addition, the method of FIG. 8 can control an amount of reduction in the luminance of the green color light output from the green color pixels located in the logo region of the image to be greater than an amount of reduction in the luminance of the red color light output from the red color pixels located in the logo region of the image.

Here, an amount of reduction in the luminance of the blue color light, an amount of reduction in the luminance of the green color light, and an amount of reduction in the luminance of the red color light are not absolute but are relative. In other words, an amount of reduction in the luminance of the blue color light, an amount of reduction in the luminance of the green color light, and an amount of reduction in the luminance of the red color light may differ from each other as long as a color change of the logo region of the image is within a predetermined range (e.g., minimized).

For example, for the red color pixel, since a difference CWR between the target luminance TR of the red color light of the logo region of the image and the average luminance AR of the red color light of the logo surrounding region of the image is relatively large, an amount of reduction in the luminance of the red color light may be relatively small when the luminance of the red color light of the logo region of the image is reduced to be substantially the same as the target luminance TR of the red color light. In addition, for the green color pixel, since a difference CWG between the target luminance TG of the green color light of the logo region of the image and the average luminance AG of the green color light of the logo surrounding region of the image is less than the difference CWR between the target luminance TR of the red color light of the logo region of the image and the average luminance AR of the red color light of the logo surrounding region of the image, an amount of reduction in the luminance of the green color light may be greater than an amount of reduction in the luminance of the red color light. Furthermore, for the blue color pixel, since a difference CWB between the target luminance TB of the blue color light of the logo region of the image and the average luminance AB of the blue color light of the logo surrounding region of the image is relatively small, an amount of reduction in the luminance of the blue color light may be relatively large when the luminance of the blue color light of the logo region of the image is reduced to be substantially the same as the target luminance TB of the blue color light.

Here, as illustrated in FIG. 10, when the degree of degradation of the red color pixel is relatively high in the logo region of the image, the method of FIG. 8 can increase an amount of reduction in the luminance of the red color pixel located in the logo region of the image because slowing the degradation of the red color pixel is required. As a result, the difference CWR between the target luminance TR of the red color light of the logo region of the image and the average luminance AR of the red color light of the logo surrounding region of the image may be reduced (indicated as an adjusted difference MCWR). That is, the target luminance TR of the red color light can be changed to an adjusted target luminance MTR.

Although it is illustrated in FIG. 10 that the target luminance TR of the red color light, the target luminance TG of the green color light, and the target luminance TB of the blue color light are determined to be respectively greater than the average luminance AR of the red color light, the average luminance AG of the green color light, and the average luminance AB of the blue color light, the determination of the target luminance TR, TG, and TB is not limited thereto. For example, the target luminance TR of the red color light, the target luminance TG of the green color light, and the target luminance TB of the blue color light can be determined to be respectively less than the average luminance AR of the red color light, the average luminance AG of the green color light, and the average luminance AB of the blue color light. In this embodiment, it should be understood that an amount of reduction in the luminance of the light increases as a difference CWR, CWG, and CWB between the target luminance TR, TG, and TB of the logo region of the image and the average luminance AR, AG, and AB of the logo surrounding region of the image increases.

In brief, the method of FIG. 8 can efficiently reflect pixel characteristics related to the lifetime of the display panel by preferentially reducing the luminance of the light (e.g., the blue color light) that is output from the pixel that is vulnerable to degradation (e.g., the blue color pixel) and by additionally adjusting an amount of reduction in the luminance of the light based on the degradation information of respective pixels when the method of FIG. 8 reduces the luminance of the logo region of the image displayed on the display panel to alleviate a permanent afterimage due to a luminance difference or a color difference between the logo region of the image and the non-logo region of the image.

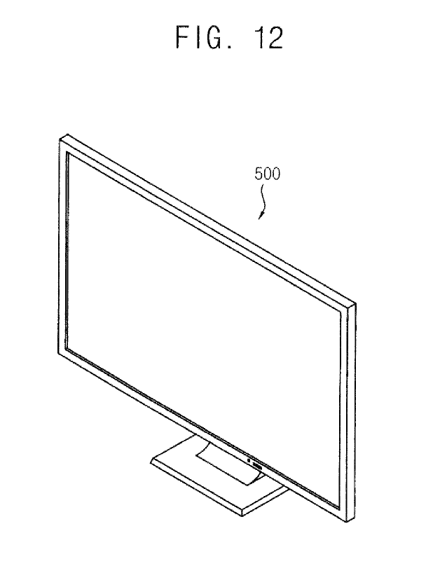

FIG. 11 is a block diagram illustrating an electronic device according to example embodiments. FIG. 12 is a diagram illustrating an example in which the electronic device of FIG. 11 is implemented as a television.

Referring to FIGS. 11 and 12, the electronic device 500 includes a processor 510, a memory device 520, a storage device 530, an input/output (I/O) device 540, a power supply 550, and a display device 560 which can be embodied as an OLED display. Here, the OLED display 560 may correspond to the OLED display 100 of FIG. 1. In addition, the electronic device 500 can further include a plurality of ports for communicating with a video card, a sound card, a memory card, a universal serial bus (USB) device, other electronic devices, etc. In an example embodiment, as illustrated in FIG. 12, the electronic device 500 can be implemented as a television. However, the electronic device 500 is not limited thereto. For example, the electronic device 500 can be implemented as a cellular phone, a smart phone, a video phone, a smart pad, a tablet computer, a car navigation system, a computer monitor, a laptop, a head mounted display (HMD), etc.

The processor 510 can perform various computing functions. The processor 510 may be a microprocessor, a central processing unit (CPU), an application processor (AP), etc. The processor 510 can be connected to other components via an address bus, a control bus, a data bus, etc. Further, the processor 510 can be connected to an extended bus such as a peripheral component interconnection (PCI) bus. The memory device 520 can store data for operating the electronic device 500. For example, the memory device 520 can include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 530 can be a solid state drive (SSD) device, a hard disk drive (HDD) device, a CD-ROM device, etc.

The I/O device 540 can include an input device such as a keyboard, a keypad, a mouse device, a touchpad, a touch-screen, etc., and an output device such as a printer, a speaker, etc. The power supply 550 can provide power for operations of the electronic device 500. In some example embodiments, the OLED display 560 can be included in the I/O device 540. The OLED display 560 can be connected to other components via the buses or other communication links. As described above, the OLED display 560 can efficiently reflect pixel characteristics related to a lifetime of a display panel by preferentially reducing the luminance of light (e.g., blue color light) that is output from a pixel that is vulnerable to degradation (e.g., blue color pixel) and by additionally adjusting an amount of reduction in luminance of the light based on degradation information of respective pixels when the OLED display 560 reduces the luminance of a logo region of an image displayed on the display panel 120 to alleviate a permanent afterimage caused due to a luminance difference or a color difference between the logo region of the image and a non-logo region of the image.

To this end, the OLED display 560 can include the display panel that displays the image including the logo region and a display driving integrated circuit that drives the display panel. The display panel can include a red color pixel that outputs red color light, a green color pixel that outputs green color light, and a blue color pixel that outputs blue color light. The display driving integrated circuit can reduce the luminance of the logo region of the image by reducing the luminance of the blue color light output from the blue color pixel located in the logo region of the image.

In an example embodiment, the display driving integrated circuit can further reduce the luminance of the logo region of the image by reducing the luminance of the green color light output from the green color pixel located in the logo region of the image. In another example embodiment, the display driving integrated circuit can further reduce the luminance of the logo region of the image by reducing the luminance of the red color light output from the red color pixel located in the logo region of the image. In still another example embodiment, the display driving integrated circuit can further reduce the luminance of the logo region of the image by reducing the luminance of the green color light output from the green color pixel located in the logo region of the image and the luminance of the red color light output from the red color pixel located in the logo region of the image. Since these embodiments are described above, duplicated descriptions thereof will not be repeated. Although an OLED display is suggested as a display device to describe the described technology, the described technology is not limited to an OLED display. For example, the described technology can be applied to various display devices each having different pixel characteristics related to a lifetime of a display panel.

The described technology can be applied to an OLED display and an electronic device including the OLED display. For example, the described technology can be applied to a smart watch, a cellular phone, a smart phone, a video phone, a smart pad, a tablet computer, a car navigation system, a television, a computer monitor, a laptop, a head mounted display (HMD), etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An organic light-emitting diode (OLED) display, comprising:
a display panel configured to display an image including a logo region, wherein the display panel comprises a plurality of red, green, and blue color pixels; and
a display driver configured to: i) drive the display panel and ii) reduce the luminance of blue color light emitted from first blue color pixels located in the logo region.

2. The display of claim 1, wherein the display driver is further configured to:
determine a logo surrounding region that surrounds the logo region;
calculate an average luminance of the blue color light emitted from second blue color pixels located in the logo surrounding region;
determine a target luminance of the blue color light emitted from the first blue color pixels based on the average luminance of the blue color light emitted from the second blue color pixels; and
reduce the luminance of the blue color light emitted from the first blue color pixels to be substantially the same as the target luminance.

3. The display of claim 1, wherein the display driver is further configured to adjust an amount of reduction in the luminance of the blue color light emitted from the first blue color pixels based on degradation information of the first blue color pixels.

4. The display of claim 3, wherein the display driver is further configured to increase the amount of reduction in the luminance of the blue color light emitted from the first blue color pixels as a degree of degradation of the first blue color pixels increases.

5. The display of claim 1, wherein the display driver is further configured to:
reduce the luminance of green color light emitted from first green color pixels located in the logo region; and
reduce the luminance of the first blue color pixels by an amount that is greater than an amount of reduction in the luminance of the first green color pixels.

6. The display of claim 5, wherein the display driver is further configured to:
determine a logo surrounding region that surrounds the logo region;
calculate an average luminance of the blue color light emitted from second blue color pixels located in the logo surrounding region and an average luminance of the green color light emitted from second green color pixels located in the logo surrounding region;
determine a blue target luminance of the blue color light emitted from the first blue color pixels and a green target luminance of the green color light emitted from the first green color pixels based on the average luminance of the blue color light emitted from the second blue color pixels and the average luminance of the green color light emitted from the second green color pixels; and
reduce the luminance of the blue color light emitted from the first blue color pixels to be substantially the same as the blue target luminance and the luminance of the green color light emitted from the first green color pixels to be substantially the same as the green target luminance.

7. The display of claim 5, wherein the display driver is further configured to:
adjust the amount of reduction in the luminance of the first blue color pixels based on degradation information of the first blue color pixels; and
adjust the amount of reduction in the luminance of the first green color pixels based on degradation information of the first green color pixels.

8. The display of claim 7, wherein the display driver is further configured to:
increase the amount of reduction in the luminance of the first blue color pixels as a degree of degradation of the first blue color pixels increases; and
increase the amount of reduction in the luminance of the first green color pixels as a degree of degradation of the first green color pixels increases.

9. The display of claim 1, wherein the display driver is further configured to:
reduce the luminance of red color light emitted from first red color pixels located in the logo region; and
reduce the luminance of the first blue color pixels by an amount that is greater than an amount of reduction in the luminance of the first red color pixels.

10. The display of claim 9, wherein the display driver is further configured to:
determine a logo surrounding region that surrounds the logo region;
calculate an average luminance of the blue color light emitted by second blue color pixels located in the logo surrounding region and an average luminance of the red color light emitted from second red color pixels located in the logo surrounding region;
determine a blue target luminance of the blue color light emitted from the first blue color pixels and a target luminance of the red color light emitted from the first red color pixels based on the average luminance of the blue color light emitted from the first blue color pixels and the average luminance of the red color light emitted from the first red color pixels; and
reduce the luminance of the blue color light emitted from the first blue color pixels to be substantially the same as the blue target luminance and the luminance of the red color light emitted from the first red color pixels to be substantially the same as the red target luminance.

11. The display of claim 9, wherein the display driver is further configured to:
adjust the amount of reduction in the luminance of the first blue color pixels based on degradation information of the first blue color pixels, and
adjust the amount of reduction in the luminance of the first red color pixels based on degradation information of the first red color pixels.

12. The display of claim 11, wherein the display driver is further configured to:
increase the amount of reduction in the luminance of the first blue color pixels as a degree of degradation of the first blue color pixels increases; and
increase the amount of reduction in the luminance of the first red color pixels as a degree of degradation of the first red color pixels increases.

13. The display of claim 1, wherein the display driver is further configured to:
reduce the luminance of green color light emitted from first green color pixels located in the logo region and luminance of red color light emitted from first red color pixels located in the logo region,
reduce the luminance of the first blue color pixels by an amount that is greater than an amount of reduction in the luminance of the first green color pixels and an amount of reduction in the luminance of the first red color pixels, and
reduce the luminance of the first green color pixels by an amount that is greater than the amount of reduction in the luminance of the first red color pixels.

14. The display of claim 13, wherein the display driver is further configured to:
determine a logo surrounding region that surrounds the logo region;
calculate i) an average luminance of the blue color light emitted by second blue color pixels located in the logo surrounding region, ii) an average luminance of the green color light emitted by second green color pixels located in the logo surrounding region, and iii) an average luminance of the red color light emitted by second red color pixels located in the logo surrounding region;
determine i) a blue target luminance of the blue color light emitted from the first blue color pixels, ii) a green target luminance of the green color light emitted from the first green color pixels, and iii) a red target luminance of the red color light emitted from the first red color pixels based on the average luminance of the blue color light emitted from the first blue color pixels, the average luminance of the green color light emitted from the first blue color pixels, and the average luminance of the red color light emitted from the first blue color pixels; and
reduce i) the luminance of the blue color light emitted from the first blue color pixels to be substantially the same as the blue target luminance, ii) the luminance of the green color light emitted from the first green color pixels to be substantially the same as the green target luminance, and iii) the luminance of the red color light emitted from the first red color pixels to be substantially the same as the red target luminance.

15. The display of claim 13, wherein the display driver is further configured to:
adjust the amount of reduction in the luminance of the first blue color pixels based on degradation information of the first blue color pixels;
adjust the amount of reduction in the luminance of the first green color pixels based on degradation information of the first green color pixels; and
adjust the amount of reduction in the luminance of the first red color pixels based on degradation information of the first red color pixels.

16. The display of claim 15, wherein the display driver is further configured to:
increase the amount of reduction in the luminance of the first blue color pixels as a degree of degradation of the first blue color pixels increases;
increase the amount of reduction in the luminance of the first green color pixels as a degree of degradation of the first green color pixels increases; and
increase the amount of reduction in the luminance of the first red color pixels as a degree of degradation of the first red color pixels increases.

17. The display of claim 1, wherein the display driver comprises:
a scan driver configured to provide a plurality of scan signals to the display panel;
a data driver configured to provide a plurality of data signals to the display panel;
a logo controller configured to generate compensated image data by reducing the luminance of the logo region on initial image data; and
a timing controller configured to control the scan driver, the data driver, and the logo controller.

18. The display of claim 17, wherein the display driver further comprises:
a memory configured to store degradation information of each of the first blue, green, and red color pixels.

19. A method of adjusting the luminance of a logo region of an image for display by an organic light-emitting diode (OLED) display, the method comprising:
detecting a logo region of the image that is displayed on the OLED display;
determining a logo surrounding region display on the OLED display that surrounds the logo region;
calculating i) an average luminance of blue color light emitted by second blue color pixels located in the logo surrounding region, ii) an average luminance of green color light emitted by second green color pixels located in the logo surrounding region, and iii) an average luminance of red color light emitted by second red color pixels located in the logo surrounding region;
determining i) a blue target luminance of blue color light emitted by first blue color pixels located in the logo region, ii) a green target luminance of green color light emitted by first green color pixels located in the logo region, and iii) a red target luminance of red color light emitted by first red color pixels located in the logo region based on the average luminance of the blue color light emitted by the second blue color pixels, the average luminance of the green color light emitted by the second green color pixels, and the average luminance of the red color light emitted by the second blue color pixels; and
reducing i) the luminance of the blue color light emitted by the first blue color pixels to be substantially the same as the blue target luminance, ii) the luminance of the green color light emitted by the first green color pixels to be substantially the same as the green target luminance, and iii) the luminance of the red color light emitted by the first red color pixels to be substantially the same as the red target luminance,
wherein an amount of reduction in luminance of the blue color light emitted by the first blue color pixels is determined to be greater than an amount of reduction in luminance of the green color light emitted by the first green color pixels and an amount of reduction in luminance of the red color light emitted by the first red color pixels, and
wherein the amount of reduction in the luminance of the green color light emitted by the first green color pixels is determined to be greater than the amount of reduction in the luminance of the red color light emitted by the first red color pixels.

20. The method of claim 19, wherein the amount of reduction in the luminance of the blue color light emitted by the first blue color pixels increases as a degree of degradation of the first blue color pixels increases,
wherein the amount of reduction in the luminance of the first green color pixels increases as a degree of degradation of the first green color pixels increases, and
wherein the amount of reduction in the luminance of the first red color pixels increases as a degree of degradation of the first red color pixels increases.
